(19) United States
(12) Patent Application Publication
(10) Pub. No.: US 2006/0005115 A1
(43) Pub. Date: Jan. 5, 2006

(54) Method for facilitating the entry of mathematical expressions

(76) Inventors: Steven Ritter, Pittsburgh, PA (US); Leslie Wheeler, Pittsburgh, PA (US); Matthew McHenry, Pittsburgh, PA (US)

Correspondence Address: Barry I. Friedman, Esq.;Metz Lewis LLC, 18th Floor, 11 Stanwix Street, Pittsburgh, PA, 15222, US

(21) Appl. No.: 10/882,027

(22) Filed: Jun. 30, 2004

(51) Int. Cl. G06F 17/24; G06F 17/21

(52) U.S. Cl. 715/503

(57) ABSTRACT

A method of facilitating the entry of a mathematical expression into a workspace provided by a software application is described. The method includes receiving a plurality of characters input into the workspace by a user and, preferably, determining whether the characters represent a mathematical expression having at least a predetermined level of complexity. If the characters represent a mathematical expression having at least a predetermined level of complexity, the method further includes converting the characters to a corresponding mathematical representation and creating an image of the mathematical representation and displaying the image to the user, preferably at a location adjacent to the workspace and optionally replacing the character's input into the workspace with the image of mathematical representation. Alternatively, the method may further include the steps of determining whether the mathematical representation is in a simplified form, and if not, providing an indication to the user of this fact.

### FIELD OF THE INVENTION

The present invention relates to software that requires the entry of mathematical expressions, and in particular to a method for facilitating the entry of mathematical expression by the user.

### BACKGROUND

A number of computer software applications require a user to input mathematical expressions. Such software applications include, without limitation, spreadsheets and educational programs such as math tutoring programs. In such applications, users are required to enter complex mathematical expressions using the keyboard of a computer. The expressions are often entered into a cell forming a part of a spreadsheet, a worksheet, a dialog box or some other similar workspace provided and displayed by the software on the computer running the application.

A number of characteristics of mathematical expressions pose problems when such expressions are to be entered by a user using a keyboard as described above. For example, many aspects of mathematical expressions, such as a fraction, are spatial in nature. As such, unlike prose, mathematical expressions are not a pure left to right writing system. As a result, mathematical expressions are much better suited to be handwritten than typed using a keyboard. Also, mathematical expressions often require special characters, such as Greek letters, and special formatting, such as exponents. Again, these aspects of mathematical typography make it difficult to use a standard keyboard to correctly, without confusion, enter a mathematical expression. For example, a user may type the following expression left to right using a standard keyboard: 25+5/2X. This expression could, however, be interpreted in the following two ways, only one of which will be correct:

$$25 + \frac{5}{2 X} ; or 25 + ( \frac{5}{2} ) X . \qquad ( 1 )$$

Also, because a standard keyboard does not include a way to easily enter and/or format mathematical symbols and expressions, special predetermined characters or words that correspond to mathematical symbols or formatting must by input using the keyboard when typing a mathematical expression. For example, an exponent is often input as Xˆ2, which corresponds to X², Greek letters such as II or Σ are often spelled out as pi and sigma when input, and certain operations, such as a square root, are often spelled out, e.g., sqrt (81). Because these typed characters do not correspond to the common visual and spatial representation of mathematical expressions, they are often confusing to a user when input. Thus, a method and system are needed that will help a user to correctly enter a mathematical expression into a software application using a standard keyboard.

One prior art approach used on, for example, word processing and educational software is to provide a template to a user when the user is required to enter a mathematical expression such as an expression including a fraction. For example, in such a system a dialog box may appear on the screen when a user desires to enter a fraction. Such a dialog box will typically include a template having a horizontal fraction bar with an empty box on top of the bar and an empty box on the bottom of the bar. The user is then prompted to enter a numerator for the fraction, which is the top box and a denominator for the fraction in the bottom box. When completed, the user typically clicks an “OK” button and the fraction is entered in the appropriate place. Such an approach requires a user to be able to envision what the expression is to look like before it is entered and to be able to select the proper template to use. As a result, this approach is not well suited for students just learning about mathematical expressions.

An additional technique has been utilized which incorporates which provides a dialog box upon the command of the user for the input of mathematical equations. In this implementation, a text box is provided within the dialog box and receives input from the user in the form of text, including all conventional representations of mathematical operators as described above, e.g., Xˆ2 for X² and sqrt(X) for √X. The implementation then converts the text to a visual, formatted mathematical expression in a graphics box within the dialog box. Completion of the expression and execution of an appropriate command inserts the mathematical expression in an underlying document or screen.

What is lacking in the art, therefore, is the ability to detect the need for a graphic representation of a complex mathematical expression and provide an appropriate mechanism for the design and insertion of such complex mathematical expression in an underlying document or screen. Also lacking in the art is the ability to detect the completion of such a complex mathematical expression such that the operators and other punctuation included therein are parsed and simplified for clarity of expression.

### SUMMARY OF THE INVENTION

The present invention relates to a method of facilitating the entry of a mathematical expression into a workspace provided by a software application. The method includes receiving a plurality of characters input into the workspace by a user and, preferably, determining whether the characters represent a mathematical expression having at least a predetermined level of complexity. If the characters represent a mathematical expression having at least a predetermined level of complexity, the method further includes automatically establishing a facility for converting the characters to a corresponding, spatially accurate mathematical representation and creating an image of the mathematical representation, which is tied to that workspace and displaying the image to the user. Preferably, the displaying step further includes displaying the image at a location adjacent to the workspace. The method may also further include the step of replacing the character's input into the workspace with the image of mathematical representation. Alternatively, the method may further include the steps of determining whether the mathematical representation is in a simplified form, and if not, providing an indication to the user of this fact.

In the preferred embodiment, the converting step includes parsing the characters into a semantic representation and converting the semantic representation to a mathematical mark-up language to create the corresponding mathematical representation. The mathematical mark-up language may be MathML or TeX. In another embodiment, the converting step includes parsing the characters into a semantic representation and the method further includes providing an indication to the user if the characters are determined to not parse properly. The indication may include making a background of the image a particular color, such as gray. In yet another embodiment, the method further includes determining whether the user has entered a complete, parsed expression, and replacing the character's input into the workspace with the image of the mathematical representation.

### BRIEF DESCRIPTION OF THE DRAWINGS

Further features and advantages of the present invention will be apparent upon consideration of the following detailed description of the present invention, taken in conjunction with the following drawings, in which like reference characters refer to like parts, and in which:

FIG. 1 is a flow diagram illustrating a methodology for facilitating the correct entry of mathematical expressions into a software application;

FIG. 1A is a flow diagram illustrating an alternative embodiment of a methodology for facilitating the correct entry of mathematical expressions into a software application; and

FIG. 2 is a representation of a coversheet forming a part of a software application according to the present invention.

### DETAILED DESCRIPTION OF THE PREFERRED EMBODIMENTS

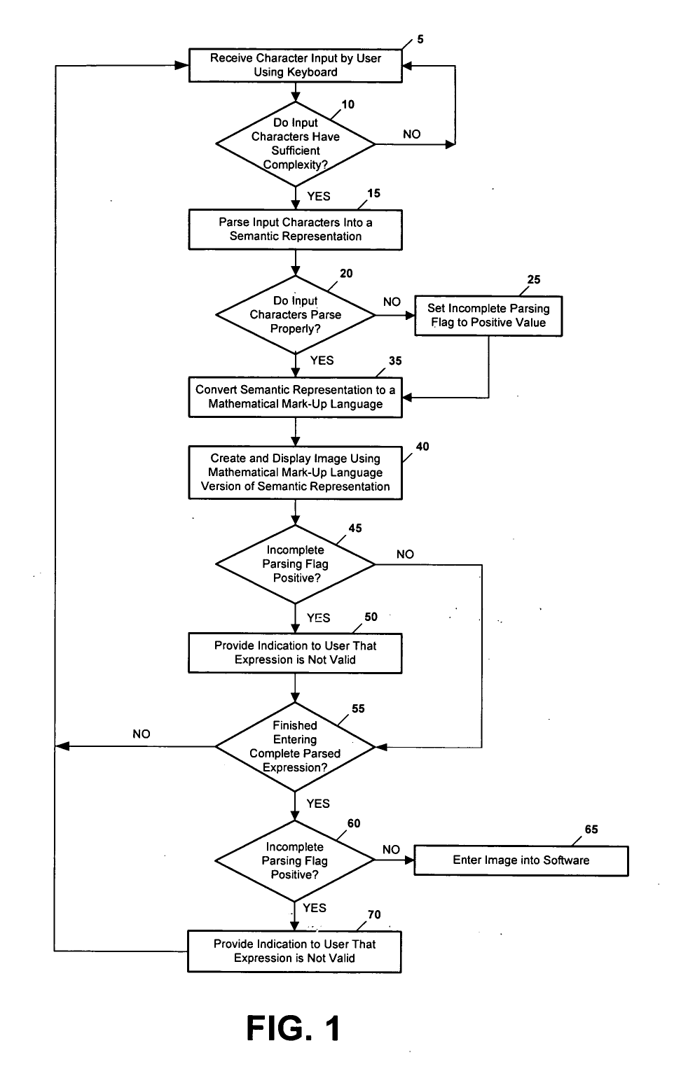

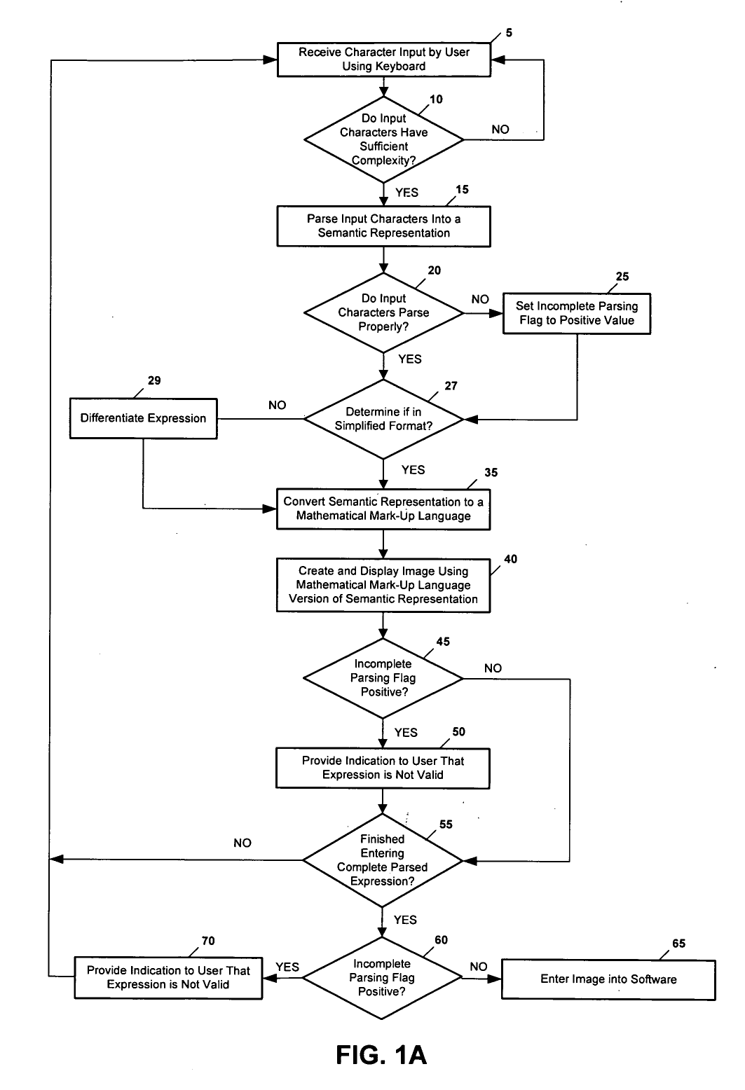

The present invention relates to a methodology and system for facilitating the correct entry of mathematical expressions in which a user may type mathematical expressions using a keyboard and receive immediate visual feedback of how the typed characters are being interpreted and what the mathematical expression will actually look like, and thus how it will operate, in a conventional mathematical format. FIG. 1 is a flow diagram illustrating a method of facilitating the correct entry of mathematical expression according to the present invention. As will be appreciated, the method shown in FIG. 1 may be implemented in software stored on a tangible medium such as a CD or hard drive and executed by the central processing unit of a computer.

As shown in step 5 of FIG. 1, each character input by the user using the keyboard is received and stored. Next, as shown in step 10, a determination is made as to whether the characters input by the user up until that point represent a mathematical expression of sufficient complexity such that the linear typed representation input by the user is inadequate and thus the expression is in need of proper formatting according to the present invention. This is accomplished by establishing a specific list of common characters, operators, variables, variable types and text expressions which might place the mathematical expression into the complex category. Each character entered into the underlying document, cell or screen is evaluated with respect to presence on the list. If the answer is no, the method returns to step 5. If, however, the answer in step 10 is yes, meaning the input characters are of sufficient complexity such that the nature of the formatting makes a difference in the mathematical operation performed by the input mathematical expression, the method, as shown in step 15, parses the input characters into a semantic representation of the input characters. Parsing involves the conversion of the character-based representation of the mathematical expression into a semantic representation which assigns meaning to the components of the expression. In step 15, each of the input characters is mapped to a corresponding mathematical symbol, value or operation. For example, the “ˆ” symbol, when surrounded by appropriate characters, is mapped to an exponent operation, e.g., 2ˆ3 is mapped to 2³. Methods of parsing mathematical expressions are well-known in the art. Specifically, known parsing algorithms may be embodied in a software module known as a parser through which the input characters may be processed. As seen in step 20, a determination is then made as to whether the input characters are able to be properly parsed. This is accomplished utilizing well known techniques in association with the parsing algorithms. In this specific instance, a grammar, or database of common operators, expressions and text sequences is compiled with the appropriate matching or relationships associated with such operators, expressions and text sequences. Similar to the detection of complex mathematical expressions described above, the mathematical expression is compared and evaluated with respect to this grammar database. If the input characters are not able to be properly parsed, that means that the input characters in their current state are not a valid mathematical expression. For example, such an invalid mathematical expression might be the following: 25+2/5X+. If it is determined that the input characters do not parse properly or completely, as seen in step 25, an incomplete parsing flag is set to a positive value so that an indication of an invalid mathematical expression may later be provided to the user. Next, as seen in step 35, the semantic representation is converted to a mathematical mark-up language. Mathematical mark-up languages for proper formatting of mathematical expressions are known in the art, and include, without limitation, MathML as specified by W3C, the Worldwide Web Consortium, and TeX, a well-known typesetting system that was written by Donald E. Knuth. An advancement of TeX is LaTeX2e written by Leslie Lamport. As seen in step 40, the method next creates and displays an image of the formatted mathematical expression corresponding to the input characters. The image is created from the mathematical mark-up language version of the semantic representation created in step 35. For input characters that do not parse completely, the image shows the last input expression which parsed completely. Several methodologies for creating an image from the mathematical mark-up language are well-known and publicly available. One example tool for creating such an image, from a MathML input, is embodied in the WebEQ™ Developers Suite available from Design Science, Inc. of Long Beach, Calif. As a result of step 40, an image of the mathematical expression corresponding to the characters input by the user is immediately and simultaneously displayed to the user on the monitor of the user's computer. Thus, the user is able to get real time feedback as to what the actual mathematical expression is that corresponds to the characters being input. Based on this feedback, a user can be confident that he or she is entering the desired mathematical expression properly, or alternatively, can recognize mistakes in the expression as input and take steps to correct same. In addition, because step 10 only allows the method to proceed to steps 10-70 when the input characters represent a sufficiently complex expression, the image and thus the feedback is only provided when necessary, and not when simple expressions such as 2+X are input by the user.

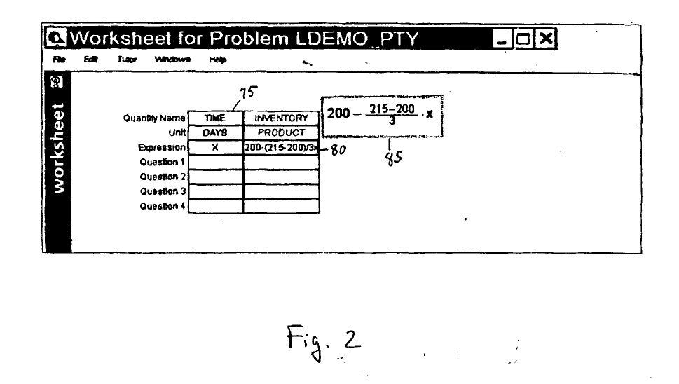

In the preferred embodiment of the present invention, the image is displayed in a tool tip window provided adjacent to the cell or other location into which the user is typing the input characters. FIG. 2 is a representation of an example worksheet 75 into which a user may enter a mathematical expression in cell 80. As seen in FIG. 2, tool tip window 85 containing an image of the mathematical representation created in step 40 that corresponds to the character's input in cell 80 is shown. Tool tip window 85 is provided in an unobtrusive location and manner that clearly indicates that it is associated with cell 80.

Returning to FIG. 1, following step 40, a determination is made in step 45 according to the preferred embodiment of the present invention as to whether the incomplete parsing flag has been set to a positive value, meaning that when parsed, it was determined that the input characters did not parse properly. If the answer in step 45 is yes, an indication is provided to the user that the mathematical expression corresponding to the characters input by the user is not valid. In the preferred embodiment, this indication may take the form of changing the background color of the tool tip window 85 to a different color, such as from white to gray. This indication is a signal to the user that a mistake is present in the input characters that needs to be corrected. If the answer in step 45 is no, meaning that the input characters did parse properly, then, at step 55, a determination is made as to whether the user has entered a complete, parsed expression. If the answer is no, then the method returns to step 5 to receive the next input character. If, however, the answer in step 55 is yes, then another determination is made, at step 60, as to whether the incomplete parsing flag is positive. If the answer in step 60 is no, meaning that the input characters have been properly parsed, then, according to the preferred embodiment of the present invention, the image of the mathematical expression is entered into the software at the precise point of departure from the document, screen or cell, as shown in step 65 and the expression as input may then be used by the software to perform one or more calculations. If, however, in step 60 it is determined that the incomplete parsing flag is positive, then, in step 70, an indication is provided to the user that the expression corresponding to the input characters is not valid. The method then returns to step 5, and waits for the user to enter additional characters in order to correct the determined invalidity.

According to an alternate embodiment as shown in FIG. 1A, a determination is made, preferably after step 25, as to whether the mathematical expression represented by the semantic representation is in the most simplified or concise form, shown as step 27. If not, then an indication of this fact is provided to the user. In the preferred embodiment, at least the portion that is not simplified is differentiated 29 in some way in the image that is displayed, such as changing it to a different color, e.g., blue. For example, if the user input “(1+2)+(3+4)”, the parenthesis are mathematically legal, in that they parse, but unnecessary, and the expression would be differentiated as described above. Similarly, the fraction 14/91 would be differentiated because it can be reduced to 1/7. The differentiation or other indication signals the user that the expression can be further simplified.

The terms and expressions which have been employed herein are used as terms of description and not as limitation, and there is no intention in the use of such terms and expressions of excluding equivalents of the features shown and described or portions thereof, it being recognized that various modifications are possible within the scope of the invention claimed. Although particular embodiments of the present invention have been illustrated in the foregoing detailed description, it is to be further understood that the present invention is not to be limited to just the embodiments disclosed, but that they are capable of numerous rearrangements, modifications and substitutions.

What is claimed is:

1. A method of facilitating the entry of a mathematical expression into a workspace provided by a software application, comprising:
receiving a plurality of characters input into said workspace by a user;
determining whether said characters represent a mathematical expression having at least a predetermined level of complexity;
converting the characters to a corresponding mathematical representation if said characters are determined to represent a mathematical expression having at least said predetermined level of complexity; and
creating an image of said mathematical representation and displaying said image to said user.

2. A method according to claim 1, said displaying step further comprising displaying said image at a location adjacent to said workspace.

3. A method according to claim 1, further comprising replacing said characters input into said workspace with said image.

4. A method according to claim 3, wherein said workspace is selected from the group consisting of a document, screen or spreadsheet cell.

5. A method according to claim 1, said converting step comprising parsing said characters into a semantic representation and converting said semantic representation to a mathematical mark-up language to create said corresponding mathematical representation.

6. A method according to claim 5, said mathematical mark-up language being MathML.

7. A method according to claim 5, said mathematical mark-up language being TeX.

8. A method according to claim 1, said converting step comprising parsing said characters, the method further comprising providing an indication to said user if said characters are determined to not parse properly.

9. A method according to claim 8, said indication comprising making a background of said image a particular color.

10. A method according to claim 1, further comprising determining whether said user has created a complete, parsed expression, and replacing said characters input into said workspace with said image.

11. A method according to claim 1, further comprising determining whether said mathematical representation is in a simplified form, and providing an indication to the user if said mathematical representation is not in a simplified form.

12. A method according to claim 11, said indication comprising a differentiation of at least a portion of said mathematical representation in said image.

13. A method according to claim 12, said differentiation comprising providing said at least a portion in a particular color.

14. A method of facilitating the entry of a mathematical expression into a workspace provided by a software application, comprising:
receiving a plurality of characters input into said workspace by a user;
converting the characters to a corresponding mathematical representation;
determining whether said mathematical representation is in a simplified form;
creating an image of said mathematical representation and displaying said image to said user; and
providing an indication to the user if said mathematical representation is not in a simplified form.

15. A method according to claim 14, said indication comprising a differentiation of at least a portion of said mathematical representation in said image.

16. A method according to claim 15, said differentiation comprising providing said at least a portion in a particular color.

17. A method according to claim 14, said displaying step further comprising displaying said image at a location adjacent to said workspace.

18. A method according to claim 14, said converting step comprising parsing said characters into semantic representation and converting said semantic representation to a mathematical mark-up language to create said corresponding mathematical representation.

19. A method according to claim 18, said mathematical mark-up language being MathML.

20. A method according to claim 18, said mathematical mark-up language being TeX.

21. A method according to claim 14, said converting step comprising parsing said characters, the method further comprising providing a second indication to said user if said characters are determined to not parse properly.

22. A method according to claim 21, said second indication comprising making a background of said image a particular second color.
